(19) United States
(12) Patent Application Publication
(10) Pub. No.: US 2014/0156418 A1
(43) Pub. Date: Jun. 5, 2014

(54) TRADING COMMUNITY PLATFORM AND METHOD

(71) Applicant: ExpoBee Ltd., Hod Hasharon (IL)

(72) Inventors: Motti KLEINMANN, Hod Hasharon (IL); Gershon KATZ, Raanana (IL)

(73) Assignee: ExpoBee Ltd., Hod Hasharon (IL)

(21) Appl. No.: 14/097,219

(22) Filed: Dec. 4, 2013

Related U.S. Application Data
(60) Provisional application No. 61/733,003, filed on Dec. 4, 2012.

(51) Int. Cl. G06Q 30/02

(52) U.S. Cl. CPC G06Q 30/0269
USPC 705/14.66

(57) ABSTRACT

A trading community platform, method and system is provided, comprising a monitoring module to monitor the behavior of at least one user both off-line and on-line, wherein the user is a member of a community; a profiling module, wherein the profiling module uses data collected from the user monitoring module and generates an enhanced user profile; and a matching module, configured to use data from the monitoring module and profiling module to suggest possible matches between at least a first member of the community and at least a second member of the community or to at least one content item or to at least one prospective service.

### BACKGROUND

1. Technical Field

The present invention relates to a system and method for profiling users, and particularly for using information collected from tracking of users and from the web to create and constantly improve user profiles, and to match said users with other users, relevant industry content, and relevant services

2. Discussion of the Related Art

The modern world of media and advertising allocates a great value to the ability to create accurate user profiles. Accurate user profiles allow advertisers to better target their ads to a particular audience. Service providers can use profiling to provide a better and more relevant service. The uses of targeted profiling are endless.

Specifically, in trade events, profiling can be used to offer users to meet other users with relevant interests, and to offer the participants of trade invents relevant services, such as professional development.

Most recent innovation in profiling users has been focused on monitoring user behavior on-line, over the internet. Far less effort has been made to track and measure user behavior in the “real” world and while participating in events, and even less effort has been used to use information taken from user monitoring in both the physical, real, world, and the on-line world.

### BRIEF SUMMARY

The present invention is directed at a system and method for monitoring, profiling and matching users based on on-line and off-line data.

The system comprises the at least the following modules: (a) a monitoring module that monitors the behavior of at least one user both off-line and on-line, the user being is a member of a community; (b) a profiling module that uses data collected from the user monitoring module and generates an enhanced user profile; and (c) a matching module, configured to use data from the monitoring module and profiling module to suggest possible matches between at least a first member of the community to at least a second member of the community or to at least one content item or to at least one prospective service.

The monitoring of the behavior off-line may be performed by tracking the behavior of the user during at least some of an event, the event being not exclusively an on-line event.

The event may be a trade event.

The system may include an additional module for facilitating off-line or on-line meetings between at least a first member of the community and at least a second member of the community.

The system may include a services module that suggests services to members of the community based on said members' profiles.

The system may further include a user monitoring module for processing online user behavior.

The profiling module previously discussed may be a learning system that constantly updates and refines users' profiles.

The matching module may include a module that assigns a quantifiable value to the quality of the match between a user and another user, a content item or a service.

The system may also include an industry data module for providing selected industry data to community members online.

The system may further include at least one filter that the user may use to personalize the data received by the industry data module.

The system may personalize the industry data and the user profiles and constantly refine and improve them and the matching algorithm may be a learning one that produces more accurate results over time.

The system may track the behavior of the users following the implementation of the industry data taken from the industry data module to further improve the user profiling.

Users of the system may have enhanced status for being both offline users and online users.

The system may be used to allocate differential revenues are acquired for offline and online users.

The method includes the followings steps: (a) monitoring a person that attends an off-line event; (b) generating a profile of said person; (c) tracking said person's online activity; (d) monitoring said person's behavior at said online event; (e) generating an enhanced user profile;

The method may include matching at least one member of the trade community with at least one other member, a content item or a service, in accordance with said enhanced user profiles;

The method may include facilitating growth of the community by providing tools to further enhance the connection of matched members.

The method may further include differential revenues that are collected based upon whether users are offline or online users

The method may further use input received from the users is used to further refine users' profiles

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic block diagram of a platform for enabling enhanced trade community development, according to some embodiments;

FIG. 2 is a flowchart illustrating a process for enabling enhanced trade community development, according to some embodiments;

FIG. 3 is a block diagram illustrating a system for enabling an online specialist community system, according to some embodiments; and

FIG. 4 is a flow chart illustrating a detailed process for enabling content processing in an online specialist community system, according to some embodiments.

It will be appreciated that for simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate corresponding or analogous elements throughout the serial views.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

In the following detailed description, numerous specific details are set forth in order to provide a thorough understanding of the present invention. However, it will be understood by those skilled in the art that the present invention may be practiced without these specific details.

The term “trade community” as used herein may encompass member or interested parties in a space or area, for example a market for professionals or users of a selected industry sector, technology, service etc. The term “trade event” as used herein may refer to any offline or online activity for a trade community, including fairs, trade shows, conferences, conventions, exhibitions, markets, professional events, networking events, research activities, data provision, or other events, gatherings, projects for prospective buyers, sellers, service providers, consumers etc.

The term “off-line” event is used here to describe an event that occurs in a physical location and where people meet each other in person (i.e. a “real world” event). An off-line event may be backed by various on-line platform and may incorporate on-line tools and hence, for the purposes of this document, an off-line event would be any event that does not occur solely on-line.

According to some embodiments, a platform and methods are provided for enhanced trade community development, by enabling community members or users to effectively connect with other users based on both offline and online user behavior and preferences.

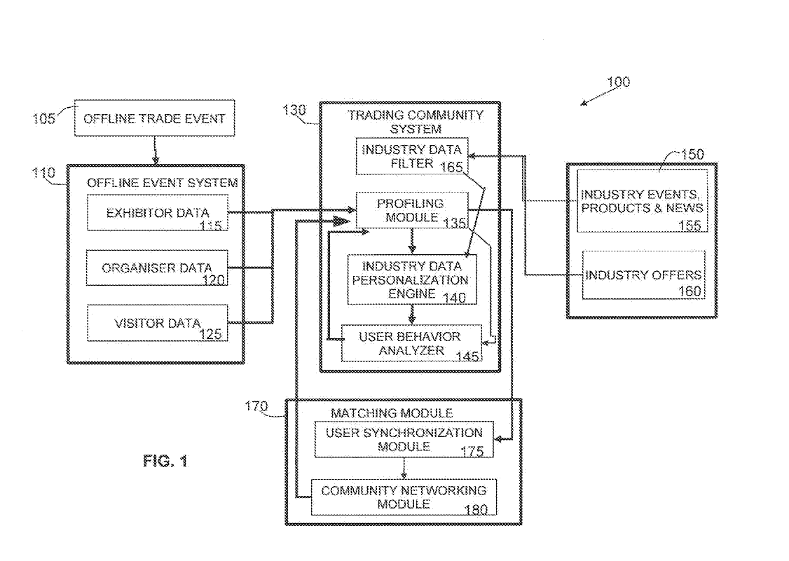

Reference is now made to FIG. 1 which is a schematic block diagram illustration of a platform for enhancing community development, which may be trade community development, according to some embodiments. As can be seen in FIG. 1, the platform 100 may include an offline event system 110, related to an offline trade event 105, an industry, specialist, or trading community system 130, and industry data module 150, and a Matching module 170. In general, participants in an off line trade event 105, such as a trade show, conference, or other off line may provide user data to the event system, such as the offline event system 110. For example, exhibitor data 115, organizer data 120, and visitor data 125, which may include, for example, registration data, member data, personal data etc. be given by the respective event participants to the event system 110. Event system 110 may be an external event management system of an integrated system that couples or interfaces with trading community system 130.

Participant data may be sent to the trading community system 130, and in particular, to the profiling module 135, which is designed to build personal profiles of users based on user specific data. For example, user profile data generated by profiling module 135 may build an initial user profile based on the event(s) a user attended, and the registration data provided, membership data provided etc. Further, the profiling module 135 may be in communication with a user behavior analyzer module 145, for processing and analyzing user specific behavior in order to add results of such analysis to the user's profile. For example, user behavior analyzer 145 may receive data relating to a user's activities, deals, attendance, booths visited, products tested etc. at the offline trade event, and may process and analyze the data to derive profile related data that may be relevant to further defining or enriching a user's profile.

In some embodiments, an industry data module 150 may be used to locate, acquire, analyze and process a wide range of industry related information, such as industry or profession related events, news, etc. In some embodiments industry related information may include information related to the user and their interests etc. Further, industry data module 150 may be used to locate, acquire, analyze and process a wide range of industry related offers or proposals etc. In some embodiments, the industry data module may use learning algorithms to collect only specific information that is relevant to the users of the community, classify it and allocate a particular rank of importance to said information. Industry data feeds or transmissions may generally be sent to trading community system 130, and specifically to the industry data filter module 165, for filtering, distilling, categorizing, tagging, rating or otherwise processing the industry related data.

Industry data filter 165 may be communicatively coupled to an industry data personalization engine 140, designed to personalize trade related data from multiple sources, in accordance with a user's profile. In some embodiments, filtered industry data may be sent to the industry data personalization engine 140, which is designed to generate data feeds to be sent to users, based on the industry data filtered by the data filter 165 and by the profiling module 135. Filtered industry data from filter 165 may send data to data personalization engine 140, to further filter or refine the industry data in accordance with user preferences. Data personalization engine 140 may send filtered industry data to platform members and may generally send follow up data to the user behavior analyzer to further process and analyze online user behavior, by user behavior module 145. For example, user choices in processing online data, such as defining categories, reading news, contributing to discussions, or connecting with people of interest, user choices of wanted materials, user choices to exclude materials, time spent reading or interacting with specific content etc, may be factored into the analyzing. Following, such analytical data may be sent to the profiling module 135 to further filter, define, categorize or otherwise enhance the user profile. In general, the system may loop between components to constantly update and upgrade user profiles.

Enhanced user profile data may be sent to the matching module 170, and particularly to the user synchronization module 175, to enable user matching or synchronization to be initiated. Networking module is adapted to match users in accordance to their enhanced profiles, typically including online and offline aspects. User matches or connections may be activated or implemented using community networking module 180, which may use various tools, elements, processes etc. allow users to communicate, cooperate, share data etc. Further, user networking activities, status, profiles etc. may be sent to the profiling module 135 to further enable the profile module to further refine or enhance the user's profiles for usage throughout the platform elements.

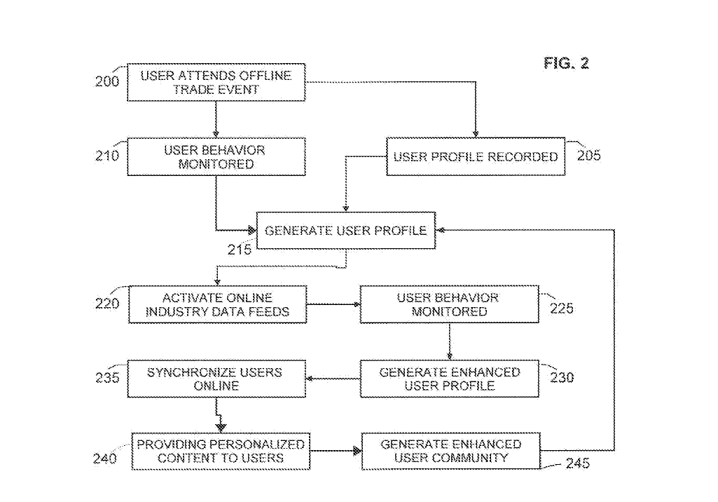

FIG. 2 schematically illustrates a series of operations or processes that may be implemented to enable enhancing trade community development, according to some embodiments. As can be seen in FIG. 2, at block 200, a user attends an offline trade event, such as a conferences, exhibition, networking event or other event. A user may include, for example, the event organizer, vendors, presenters, participants, advertisers or other users. At block 205 the user profile is recorded, in the system in which the registration or participation information is collected. At block 210, the user behavior may optionally be monitored, for example, using an event management system. At block 215 the user profile data and/or the user behavior data may be sent to a user profile generation module, to generate a user profile based on offline user activities.

At block 220 users may be engaged in one or more online events, activities etc. to compliment user online participation in a field of interest. For example, users may be sent information feeds such as industry data feeds, news items, press releases, etc, and optionally product or service offers etc. Further, user choices and/or responses in data handling may be processed, for example, users may choose to track or follow certain categories, topics, vendors, discussions etc. At block 225 user online activity may be monitored, for example, by tracking user clicks, time spend of pages, and other tools to understand user interests and areas of expertise. In some examples, users maybe allowed to edit and refine such data feeds, by defining wanted and unwanted information, ranking information in terms of importance etc. At block 230, data from user online monitoring may be sent to the user profile generation module to further refine, update or enhance the user profile, for example, by including user online activity and offline activity in the user profile.

At block 235, a networking module may match or synchronize users based on their updated profiles, thereby allowing for high resolution synchronizing of users to enable highly specialized and targeted online networking. At block 240 personalized content may be provided to users. At block 245 advanced community building, development and networking tools may be used to help develop the user's community or network online, or offline, based on the advanced user profile described above.

According to some embodiments the trade community development platform 100 may be a learning platform, as the users' profiles may be continually updated and refined, following feedback from online and/or offline sources.

In some embodiments, platform 100 may enable users to select levels of accuracy in matching or synchronizing with other users. For example, a user wanting a smaller, highly concentrated network or community may select to synchronize with other users than are substantially within 5% accuracy of their profile. Of course, other definitions and ranges may be used.

According to some embodiments, a user profile may be ranked in terms of activism, online or offline activity or behavior etc. In some embodiments user behavior may be analyzed to determine high resolution or accuracy of a user's skills, interests etc.

In further embodiment, user profiles may be multidimensional. For example, profiles may be defined by various categories, such as industries, companies, titles, positions, technology areas, positioning etc. In some implementations, a multilayer matrix of personalization may be generated to represent the respective dimensions of a users profile, and such a matrix may be continually refined and updated to represent the developing profile of each user.

According to some embodiments, users may provide comments, rankings, reviews etc. on other users. Such external information of users may be used to refine or update user profiles.

According to some embodiments, users may be provided with different status's depending on their level of offline activity and/or online activity. In further embodiments, users may be required to pay differential fees and/or receive differential revenues depending on the level of their offline activity and/or online activities.

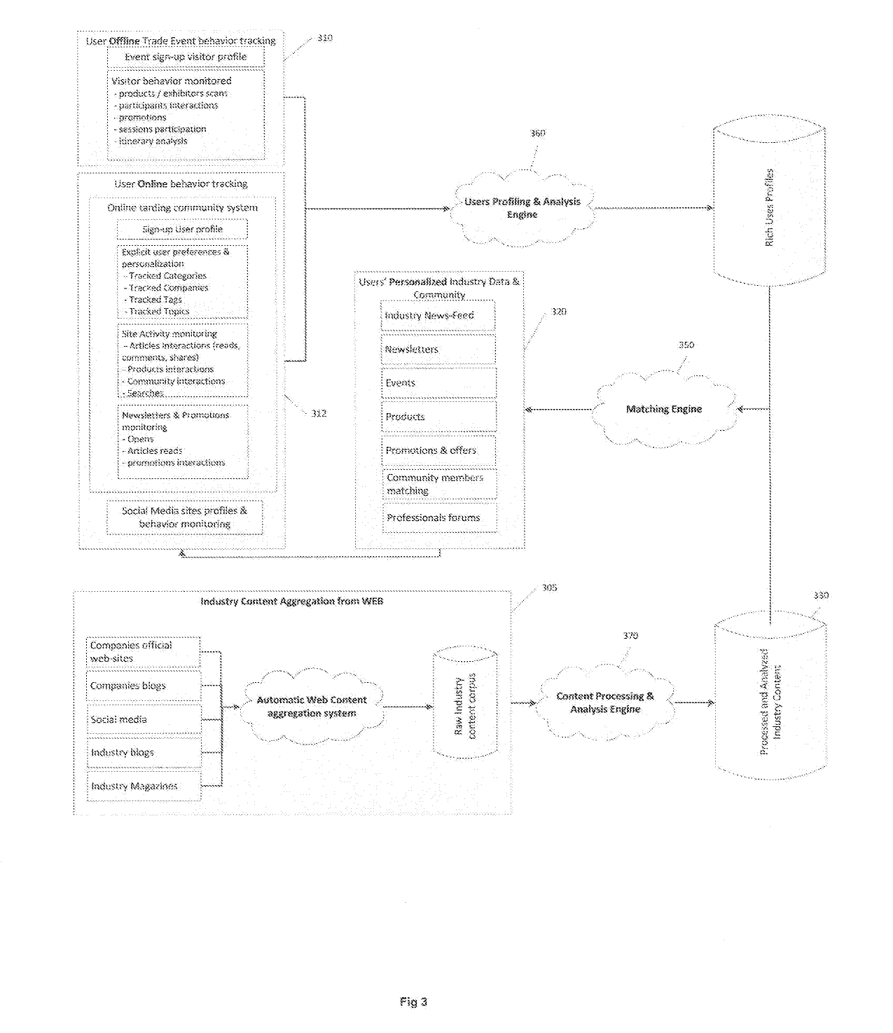

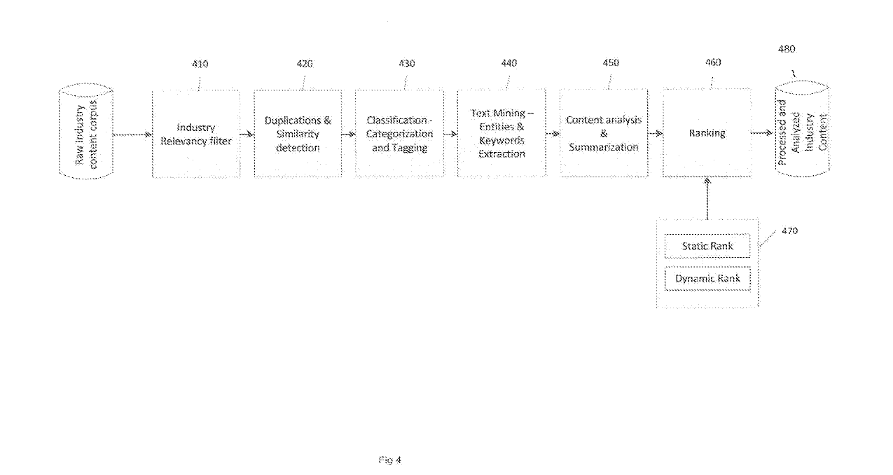

Reference is now made to FIG. 3, which is a block diagram illustrating a detailed system for enabling an online specialist community system, according to some embodiments. As can be seen, at module 310 user behavior offline may be tracked and/or monitored, for example, based on attendance and/or behaviour at an offline event. At module 312 user behavior online may be tracked and/or monitored, for example, based on attendance and/or behaviour through Websites, forums, based on data downloaded or accessed, social media sites etc. At module 360 the user behavior data may be processed and a user profile generated based on data analysis. The user profile may be stored in for example, a Rich Uses Profile Database 365. At module 305, content is acquired from multiple external sources, and is aggregated. At module 370 external (web) content is processed and analyzed (see description of FIG. 4 below). At module 330, for example, industry or community content may be tagged and prepared for access or usage. At module 350 user-content matching takes place, to connect filtered content with user profiles. At module 320 the users' personalized trading community system data may be provided for a user.

FIG. 4 is a flowchart illustrating a detailed process for enabling automated content processing and analysis from multiple data sources, as described in step 370 above. As can be seen, the content processing described above may include, for example, at step 410 filtering raw industry or other content data using an industry relevance filter algorithm. At step 420 the filtered data is analyzed to recognize duplications and redundancies. At step 430 the data undergoes classification, for example, including categorization and tagging. At step 440 Text Mining may be performed on the data, for example to extract entity and keyword data. At step 450 Content analysis and summarization may be executed. At step 460 the filtered, analyzed, processed and summarized data may be ranked. In some embodiments, at step 470, ranking may be comprised of static ranks and dynamic ranks, which may feature in the ranking of data. Further, in some embodiments, at step 480, specialized databases of processed and analyzed industry content may be used to help determine data ranking. Of course, other types of data analysis, such as natural language processing (NLP), prediction algorithms and other means to convert unstructured data to structured data may be used in any of the relevant parts of the system and any of the relevant parts of the method.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A system, comprising:
a monitoring module to monitor the behavior of at least one user both off-line and on-line, wherein the user is a member of a community;
a profiling module, wherein the profiling module uses data collected from the user monitoring module and generates an enhanced user profile;
a matching module, configured to use data from the monitoring module and profiling module to suggest possible matches between at least a first member of the community to at least a second member of the community or to at least one content item or to at least one prospective service.

2. The system of claim 1, wherein the monitoring of the behavior off-line would be performed by tracking the behavior of the user during at least some of an event, wherein said event is not exclusively an on-line event.

3. The system of claim 2, wherein said event is a trade event.

4. The system of claim 1, further comprising:
a meeting facilitation module for facilitating off-line or on-line meetings between at least a first member of the community and at least a second member of the community.

5. The system of claim 1, further comprising:
A services module, wherein said module suggests services to members of the community based on said members' profiles.

6. The system of claim 1, wherein said user monitoring module includes a user behavior analyzer for processing online user behavior.

7. The system of claim 1, wherein said profiling module is a learning system that constantly updates and refines users' profiles.

8. The system of claim 1, wherein the matching module includes a module that assigns a quantifiable value to the quality of the match between a user and another user, a content item or a service.

9. The system of claim 1, further comprising an industry data module for providing selected industry data to community members online.

10. The system of claim 9, further comprising at least one filter that the user may use to personalize the data received by the industry data module.

11. The system of claim 9, wherein the data received by the user from the industry data module may be personalized based on the user's profile, wherein the user profiles and the industry data are constantly refined and improved and wherein the matching algorithm is a learning algorithm that produces more accurate results over time.

12. The system of claim 9, wherein the behavior of the users is further tracked following the implementation of the industry data taken from the industry data module to further improve the user profiling.

13. The system of claim 1, wherein said members have enhanced status for being both offline users and online users.

14. The system of claim 1, wherein differential revenues are acquired for offline and online users.

15. A method, comprising:
monitoring a person that attends an off-line event;
generating a profile of said person;
tracking said person's online activity;
monitoring said person's behavior at said online event;
generating an enhanced user profile;
wherein the steps above are performed using at least one computer processor.

16. The method of claim 15, further comprising the step of:
matching at least one member of the trade community with at least one other member, a content item or a service, in accordance with said enhanced user profiles;

17. The method of claim 16, further comprising the step of:
Facilitating growth of the community by providing tools to further enhance the connection of matched members.

18. The method of claim 15, wherein differential revenues are collected based upon whether users are offline or online users.

19. The method of claim 15, wherein the community is a trade community.

20. The method of claim 15, wherein input received from the users is used to further refine users' profiles.
